(19) United States
(12) Patent Application Publication
(10) Pub. No.: US 2022/0371505 A1
(43) Pub. Date: Nov. 24, 2022

(54) CARGO STRAP

(71) Applicant: DrySpec LLC, East Greenwich, RI (US)

(72) Inventor: Nathan BASTIEN, Exeter, RI (US)

(21) Appl. No.: 17/748,577

(22) Filed: May 19, 2022

Related U.S. Application Data
(60) Provisional application No. 63/201,921, filed on May 19, 2021.

(51) Int. Cl. B60P 7/08

(52) U.S. Cl. CPC B60P 7/0853; B60P 7/0807

(57) ABSTRACT

A strap system for securing cargo/items to a desired location such as the frame of a vehicle and/or to other gear. The strap system includes at least a first strap segment, and more preferably, a plurality of strap segments that couple together sequentially, e.g., end-to-end, via quick-release connectors such as side-release buckles. A first strap segment (or center strap segment) includes first and second ends that removably couple to second and third strap segments, respectively, via quick-release connectors. The second and third strap segments further includes attachment members disposed at an end of each, the attachment members having a substantially C-shaped hook profile to couple to various strap anchor points such as PALS webbing.

### CROSS REFERENCE TO RELATED APPLICATIONS

The present application claims the benefit of U.S. Provisional Application Ser. No. 63/201,921, filed May 19, 2021, which is fully incorporated herein by reference.

### TECHNICAL FIELD

This specification relates generally to straps for securing cargo/items to a desired location, and more particularly, to a strap that supports a plurality of user-selected configurations via quick-release connectors to accommodate a range of different types of cargo/items, and an attachment member at an end of the strap that preferably includes a substantially C-shaped hook profile to secure such cargo/items to a desired location that includes, for example, strap anchor points implemented within Modular Lightweight Load-carrying Equipment (MOLE) systems and Pouch Attachment Ladder System (PALS) webbing.

### BACKGROUND INFORMATION

Existing straps for securing cargo and other items on to a desired location range from relatively simple bungee cords that can provide constant tension to complex webbings for specialized purposes such as for stowing military gear. Straps are often highly specialized for a particular application such as those configured to couple to standardized strap/cargo systems. Other straps include looped ends to support a range of cargo and attachment/anchor points, while still other strap types include proprietary or otherwise specialized connectors for quick-release coupling.

There exists a need for a strap that can support a wide range of cargo securing scenarios including those traditionally served by the simplicity and constant tension of a bungee cord and scenarios that require the additional strength and convenience of a quick-release strap that can couple to specialized strap systems such as webbed cargo strap systems.

### BRIEF DESCRIPTION OF THE DRAWINGS

The drawings included herewith are for illustrating various examples of articles, methods, and apparatuses of the teaching of the present specification and are not intended to limit the scope of what is taught in any way.

FIG. 1 shows an example strap system in accordance with embodiments of the present disclosure.

FIG. 2 shows an attachment member suitable for use with the strap system of FIG. 1, in accordance with an embodiment of the present disclosure.

FIG. 3 shows an example configuration of the strap system of FIG. 1, in accordance with an embodiment of the present disclosure.

FIG. 4 shows an example quick-release attachment member in isolation, in accordance with an embodiment of the present disclosure.

FIG. 5 illustrates one example of the strap system of FIG. 1 used to securely couple gear to strap anchor points provided by the frame of a motorcycle, in accordance with an embodiment.

FIG. 6 illustrates one example of the quick-release attachment member of FIGS. 2 and 3 used by the strap system of FIG. 1 to securely couple a cooler with PALS webbing to the frame of a motorcycle, in accordance with an embodiment.

FIG. 7 illustrates one example of the strap system of FIG. 1 securely coupling a first piece of gear to a second piece of gear based on a PALS webbing provided by the second piece of gear, in accordance with an embodiment.

FIG. 8 shows an enlarged view of the example embodiment of FIG. 5.

FIG. 9 illustrates another example of the strap system of FIG. 1 securely coupling gear to the frame of a motorcycle, in accordance with an embodiment.

FIG. 10 illustrates another example of the strap system of FIG. 1 used to securely couple gear to the frame of a motorcycle, in accordance with an embodiment.

FIG. 11 illustrates another example of the strap system of FIG. 1 used to securely couple gear to the frame of a motorcycle, in accordance with an embodiment.

FIG. 12 illustrates an example of the strap system of FIG. 1 used to securely couple gear to the bed of a pickup truck, in accordance with an embodiment.

FIG. 13 illustrates another example of the strap system of FIG. 1 used to securely couple gear to the frame of a motorcycle, in accordance with an embodiment.

FIG. 14 illustrates another example of the strap system of FIG. 1 securely coupling a first piece of gear to a second piece of gear based on a PALS webbing provided by the second piece of gear, in accordance with an embodiment.

FIG. 15 illustrates another example of the strap system of FIG. 1 used to securely couple gear to the bed of a truck, in accordance with an embodiment.

### DETAILED DESCRIPTION

In general, a strap system is disclosed for securing cargo/items to a desired location such as the frame of a vehicle and/or to other gear. The strap system may include at least a first strap segment, for example, a plurality of strap segments (or strap members), that couple together sequentially, e.g., end-to-end, via quick-release connectors such as side-release buckles. In this example, a first strap segment (or center strap segment) includes first and second ends that are configured to be removably coupled to second and third strap segments, respectively, via quick-release connectors. The first, second, and third strap segments may be collectively referred to as a multi-segment strap, or a multi-segment strap configuration, wherein at least two of the strap segments are coupled together. As discussed further below, the second and third strap segments may be decoupled from the first strap segment and be used as separate, independent straps for securing the same or different cargo/items depending on a desired configuration.

The first, second and third strap segments may be formed of a flexible material, such as Nylon, and couple together to collectively provide the multi-segment strap. In this configuration, the multi-segment strap can accommodate cargo with relatively large overall dimensions, and/or strap anchor points that are disposed apart from each other at a distance that would otherwise be impractical for a single strap segment to be utilized. When used, the multi-segment strap can be disposed over the top of cargo, for example, and anchored to a target/desired location at each end.

The second and third strap segments may provide the multi-segment strap with attachment members at each end. Each attachment member may be formed of a rigid material such as metal and includes a substantially C-shaped hook profile based on a stem and first and second hook portions that extend therefrom. The attachment members may also be referred to as substantially C-shaped hook attachment members, or simply substantially C-shaped hooks. Note, a strap consistent with the present disclosure may not necessarily utilize a plurality of straps segments and may instead be a single strap, e.g., without removable segments/sections. In this example, one or more ends of the single strap can include an attachment member consistent with the present disclosure.

The term strap as used herein refers to a strap for securing cargo/items that includes one or more strap segments, and that defines two opposing ends (or more) for coupling to respective strap anchor points. At least one end of the two opposing ends provides a substantially C-shaped hook attachment member consistent with aspects of the present disclosure to couple directly to strap anchor points, or indirectly by way of a removable anchor member, e.g., a closed-loop shock cord.

Strap anchor points, as generally referred to herein, include any location that a strap consistent with the present disclosure can removably couple to. Such strap anchor points can be provided by, for example, the frame of a vehicle, PALS webbing provided by gear such as a backpack or cooler, or virtually any other location a user desires to securely couple items/gear to.

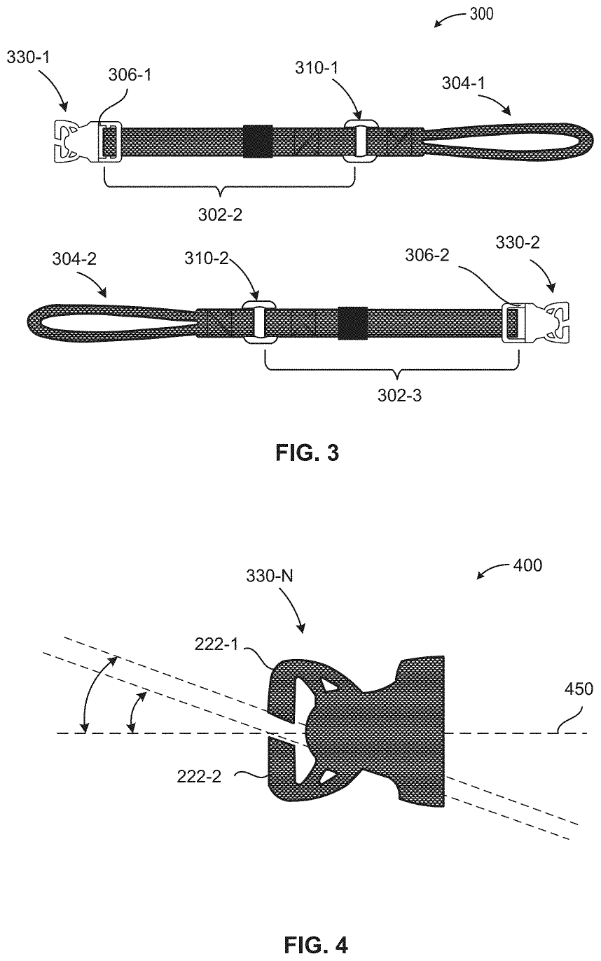

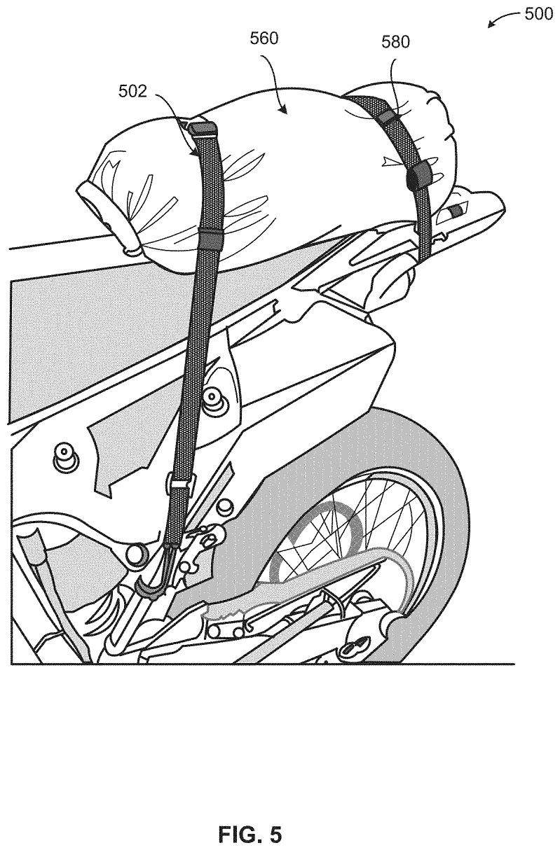

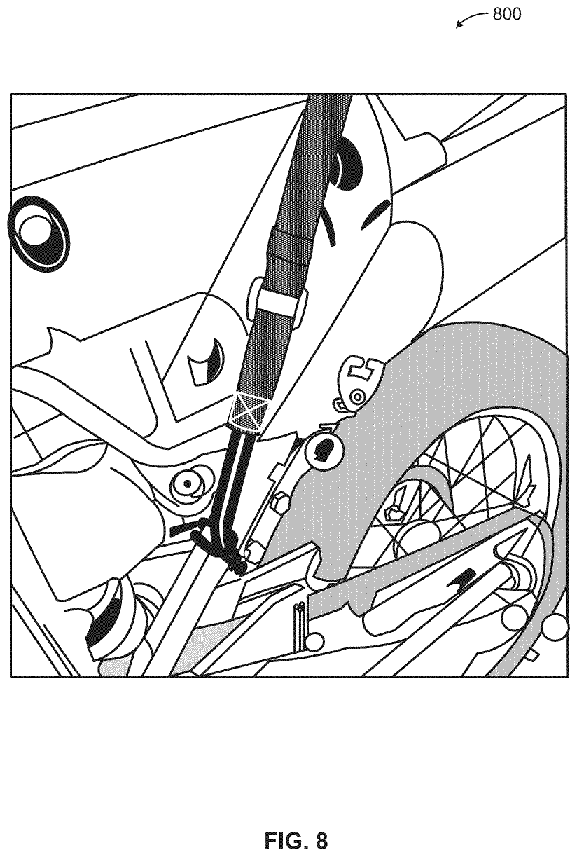

In one example, the anchor member may be a closed-loop (also referred to as a loop-end) shock cord that provides the mounting slot in the form of a fabric sleeve. An attachment member, and more particularly the first and second hook portions of the attachment member that provide a substantially C-shaped hook profile, may then be at least partially received within the fabric sleeve of the anchor member to couple the anchor member to the strap. The anchor member may then be attached to a desired location, e.g., looped about a vehicle frame such as shown in FIGS. 5 and 8. An anchor member at a second end of the strap segment can comprise, for example, a quick-release anchor member, such as is shown in FIGS. 3 and 4, or alternatively another device such as a closed-loop shock cord. Still further, the anchor member at the second end of the strap can comprise the substantially C-shaped hook attachment member to directly couple to a strap anchor point, e.g., without the use of an intermediate anchor member such as closed-loop shock cord.

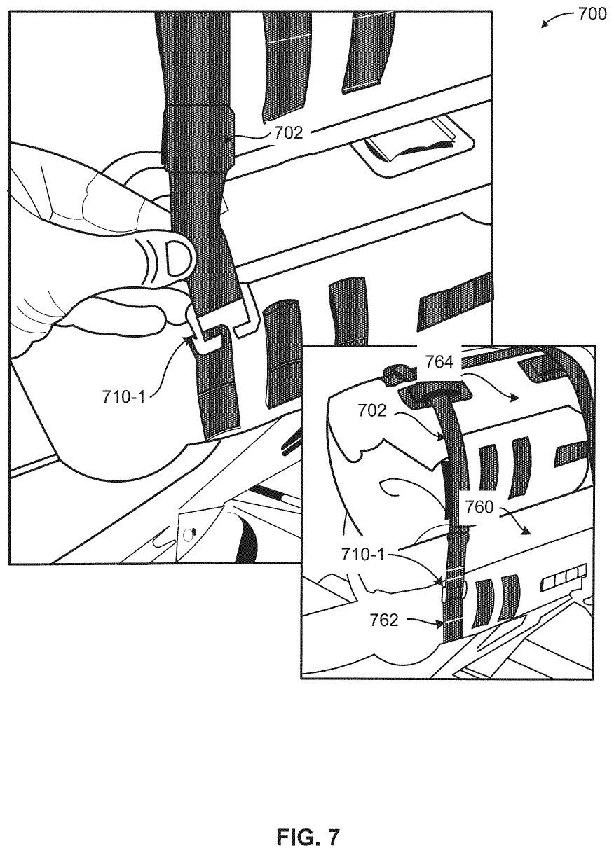

A strap consistent with the present disclosure therefore allows for each end of the same to couple directly to a target location via the anchor members, see e.g., FIG. 7, or each end to couple indirectly to a target location, e.g., via a shock cord loop such as shown in FIG. 15, or a combination of both direct and indirect coupling depending on a desired configuration. Still further, each end of the strap may be directly coupled together via the anchor members such as shown in FIG. 10, depending on a desired configuration.

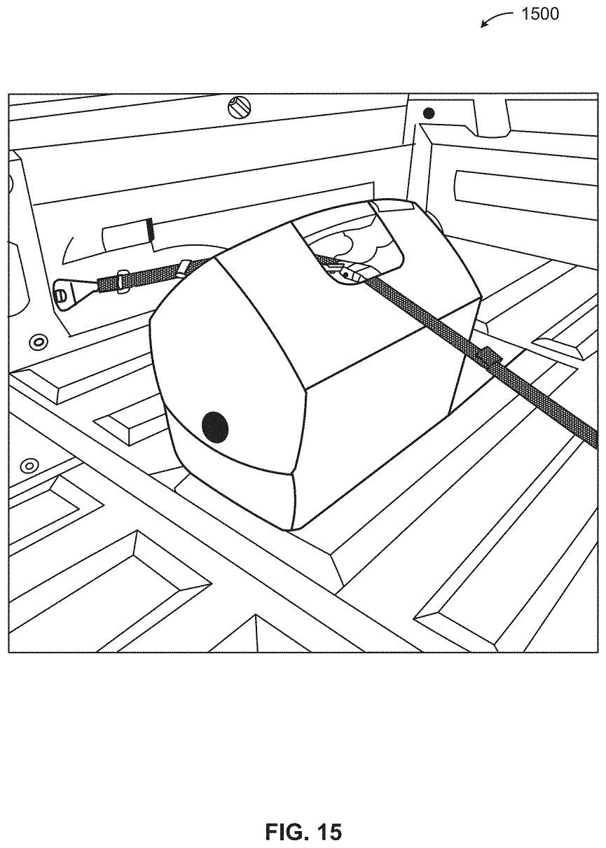

The second and third strap segments may also be separable from the first strap segment and/or each other and are configured to operate as stand-alone straps. In this example, each of the second and third strap segments can include a first end with the aforementioned attachment member and a second end that includes a quick-release anchor, such as shown and described in greater detail below in connection with FIGS. 3 and 4. Thus, each of the separated first and second strap segments can support a range of attachment options at each end without necessarily utilizing the first/center strap segment. One non-limiting example illustrating such separated second and third strap segments being utilized to secure cargo is shown in FIG. 14.

The term “coupled” as used herein refers to any connection, coupling, link or the like between elements. Such “coupled” elements are not necessarily directly connected to one another and may be separated by intermediate components or devices. The term “directly coupled” refers to a connection between elements without an intermediate component or device.

The term substantially, as generally referred to herein, refers to a degree of precision within acceptable tolerance that accounts for and reflects minor real-world variation due to material composition, material defects, and/or limitations/peculiarities in manufacturing processes. Such variation may therefore be said to achieve largely, but not necessarily wholly, the target characteristic. To provide one non-limiting numerical example to quantify “substantially,” minor variation may cause a deviation of up to and including ±10% from a target quality/characteristic unless otherwise provided by the present disclosure.

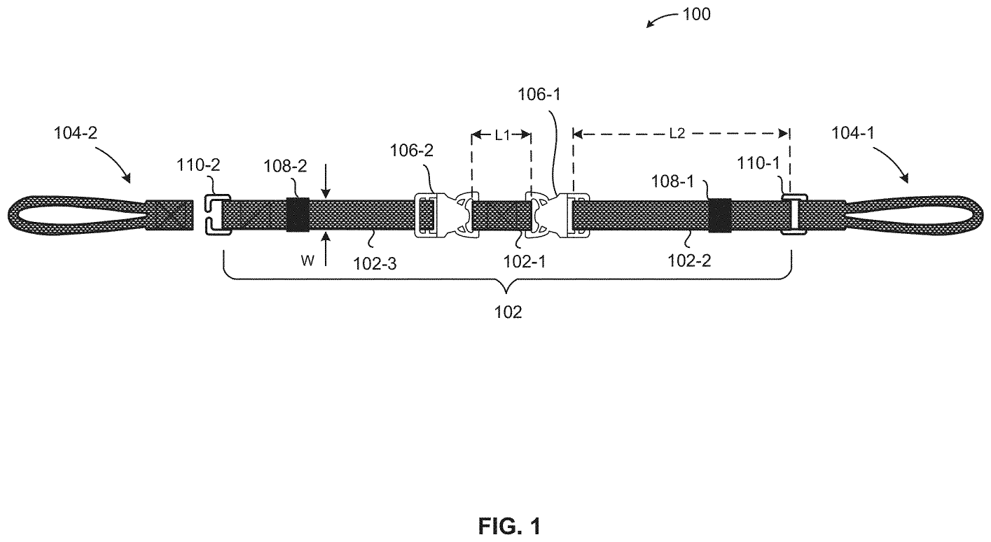

Turning to FIG. 1, an example strap system 100 in accordance with an embodiment of the present disclosure is generally illustrated. The strap system 100 may also be referred to herein as a strap mounting system, or simply a mounting system.

As shown in FIG. 1, the strap system 100 may include at least one strap having a body collectively shown at 102, and a plurality of individually as strap segments, e.g., strap segments 102-1, 102-2, and 102-3. The strap segments 102-1, 102-2, 102-3 may be referred to as first, second and third strap segments, respectively, although the qualifier of “first,” “second” and “third” is provided for purposes of differentiating between strap segments and is not intended to be limiting.

The body 102 may be comprised of strap segments 102-1 to 102-3 that removably couple to each other, and when two or more of the same are coupled together, the resulting strap may be referred to as having a multi-segment configuration or simply as a multi-segment strap. The strap segments 102-1 to 102-3 may comprise a flexible material such as leather, rubber, or synthetic rubber, and more preferably a flexible fabric material such as nylon webbing, polypropylene webbing, rubber, synthetic rubber (e.g., but not limited to, hypalon), and/or the like. Accordingly, the strap segments 102-1 to 102-3 may also be referred to herein as fabric strap segments or simply fabric segments.

The first strap segment 102-1 can be configured with a maximum overall length L1. The maximum overall length L1 can measure between 1 millimeter (mm) and 200 mm, and preferably at least 25 mm. The first strap segment 102-1 may have a fixed overall length such that the first strap segment 102-1 has a length L1 that cannot be extended/shortened by a user. Alternatively, the first strap segment 102-1 may also be configured to be adjustable to vary the overall length up to the maximum overall length L1 based on a strap adjuster (not shown).

As shown, the first strap segment 102-1 may include first and second coupling members 106-1, 106-2 disposed at opposite ends to allow for the first strap segment 102-1 to removably couple to the second and third strap segments 102-2, 102-3. The first and second coupling members 106-1, 106-2 are may be implemented as quick-release connectors. The quick-release connectors may be in the form of side-release buckles that allow a user to supply a user-supplied force, e.g., a pinching force on opposite sides of the first and second coupling members 106-1, 106-2, to cause the first strap segment 102-1 to removably decouple from the second and/or third strap segments 102-2, 102-3.

As shown, the first strap segment 102-1 may include the first and second coupling members 106-1, 106-2 implemented as side-release buckles with the female portion of the same being provided by the first strap segment 102-1 and the corresponding male portions being provided by the second and third strap segments 102-2, 102-3. The first and second side release buckles may include at least one of polypropylene, nylon, and/or acetal (e.g., but not limited to, Delrin or the like).

The second and third strap segments 102-2, 102-3 may include a first end that removably couples to the first strap segment 102-1, e.g., via first and second coupling members 106-1, 106-2, respectively. The second and third strap segments 102-2, 102-3 can include a fixed overall length L2, or can preferably be adjustable to a maximum length equal of L2. In either case, the second and third strap segments 102-2, 102-3 can both include the same maximum overall length, e.g., L2, or have a different overall maximum length. The maximum overall length L2 can measure, for example, 100 to 3000 mm. The first, second and third strap segments 102-1, 102-2, and 102-3 can include a substantially equal width W, or different widths depending on a desired configuration. The width W can measure between 12 to 400 mm, for example.

Each of the second and third strap segments 102-2, 102-3 can further include first and second strap adjusters 108-1, 108-2, respectively. The first and second strap adjusters 108-1, 108-2 can be configured to allow for respective strap segments to be lengthened/shortened. The first and second strap adjusters 108-1, 108-2 may also be referred to as strap loops.

As further shown, a second end of each of the second and third strap segments 102-2, 102-3 may include an attachment member. For example, as shown in FIG. 1, the second strap segment 102-2 includes a first attachment member 110-1 and the third strap segment 102-3 includes a second attachment member 110-2.

Each of the first and second attachment members 110-1, 110-2 are may be formed from a metal or other suitably rigid material. For example, the first and second attachment members 110-1, 110-2 may be formed from aluminum, steel, brass, plastic, nylon, and/or acetal. The first and second attachment members 110-1, 110-2 may be configured to be fixed to the second and third strap segments 102-2, 102-3, respectively, (e.g., not removable by a user) and may also be referred to as fixed attachment members herein.

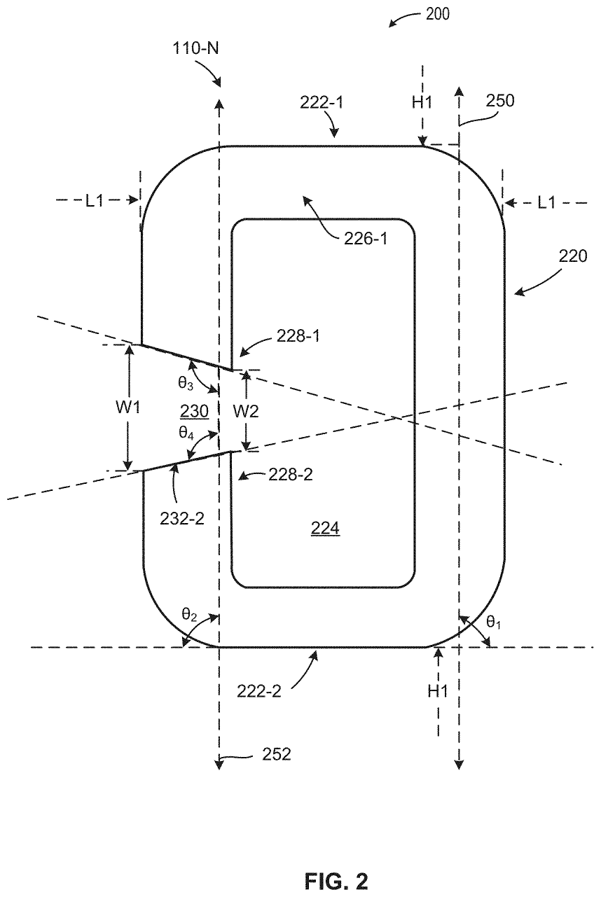

FIG. 2 shows a side view of an attachment member 110-N suitable for use as the first and/or second attachment member 110-1, 110-2 of FIG. 1. As shown, the attachment member 110-N includes a stem 220, and first and second arm portions 221-1, 221-2 extending from the stem 220. The stem 220 and the first and second arm portions 221-1, 221-2 may be formed from a single, monolithic piece of material. The stem 220 and first and second arm portions 221-1, 221-2 may define at least a first substantially coplanar surface 226-1. The first substantially coplanar surface 226-1 may be disposed opposite a second substantially coplanar surface (not shown).

As further shown, the stem 220 can be configured to be at least partially surrounded by material of the second or third strap segments 102-2, 102-3 for coupling purposes, such as shown in FIG. 1. The material of the second and/or third strap segments 102-2, 102-3 may be stitched or otherwise securely fixed to a respective stem. The stem 220 extends along a longitudinal axis 250 to an overall height H1. The overall height H1 is preferably between 12 and 450 mm.

The first and second arm portions 222-1, 222-2 extend from opposite ends of the stem 220 at a first angle (θ₁) relative to the longitudinal axis 250 such that at least a portion of the first and second arm portions 222-1, 222-2 extend substantially in parallel with each other. To this end, the first angle (θ₁) measures 90 degrees ±5 degrees, for example. The first angle (θ₁) of the first arm portion 222-1 may be the same as or different than the first angle (θ₁) of the second arm portion 222-2. The first and second arm portions 222-1, 222-2 extend to an overall length L1 and then transition to first and second hook portions 228-1, 228-2 based on at least one bend. The overall length L1 measures preferably between 10 and 75 mm.

The bend may cause each of the first and second hook portions 228-1, 228-2 to extend at a second angle (θ₂) relative to one or more axes 252 that extend through the first and second hook portions 228-1, 228-2, with the first and second angles (θ₁, θ₂) being preferably the same. The axis 252 may be a common axis, for example, that extends substantially parallel with the longitudinal axis 250. The stem 220 and first and second arm portions 221-1, 222-2 therefore define a substantially C-shaped hook profile.

Each of the first and second hook sections 228-1, 228-2 may extend toward each other along the axis 252 and include a predefined offset distance therebetween that defines an opening 230, which may also be referred to as a mouth. The opening 230 may be defined by a first angled surface 232-1 provided by the first hook section 228-1 and a second angled surface 232-2 provided by the second hook section 228-2. The first and second angled surfaces 232-1, 232-2 can extend at third and fourth angles (θ₃, θ₄) relative to the common axis 252 such that the opening 230 tapers from a first predefined width W1 to a second predefined width W2, with the first predefined width W1 being greater than the second predefined width W2.

The third and fourth angles (θ₃, θ₄) may measure between 45 and 135 degrees, and more preferably at least 90 degrees. The third and fourth angles (θ₃, θ₄) may be substantially the same or different. In addition, the first predefined width W1 measures may be between 3 and 25 mm, and the second predefined width W2 may measures less than the first predefined width W1, for example, at least 2 mm.

Accordingly, imaginary lines drawn tangent to the first and second angled surfaces 232-1, 232-2 respectively intersect. For example, imaginary lines drawn tangent to the first and second angled surfaces 232-1, 232-2 intersect at or just before the stem portion 220, as shown in FIG. 2. The opening 230 may therefore be referred to as a tapered opening. The tapered opening advantageously allows for, for instance, a portion of the first or second anchor member 104-1, 104-2 to be received and securely held within the slot 224, with the slot 224 being defined by the stem 220 and the first and second arms 222-1, 222-2 extending therefrom. Alternatively, the opening 230 may be used to removably couple the attachment member 110-N directly to a strap anchor point such as a PALS webbing, or to another attachment member 110-N having a substantially similar C-shaped hook profile (See e.g., FIG. 10).

As further shown in FIG. 1, the first and second attachment members 110-1, 110-2 may be configured to removably couple to the first and second anchor members 104-1, 104-2. As shown, first and second anchor members 104-1, 104-2 may comprise shock cord, for example, a (closed) loop of shock cord. In addition, the first and second anchor members 104-1, 104-2 may provide an anchor coupling region for removably coupling to the first and second attachment members 110-1, 110-2.

The anchor coupling region of the first and second anchor members 104-1, 104-2 may comprise, for example, flexible and elastic material such as webbing and bungee cord, shock cord. For example, the anchor coupling region of the first and second anchor members 104-1, 104-2 may provide a mounting slot. The mounting slot may be implemented as a sleeve formed from the flexible material. The sleeve may also be configured to receive first and second hook portions, e.g., first and second hook portions 228-1, 228-2 of FIG. 2, of respective ones of first and second attachment members 110-1, 110-2. The first and second hook portions 228-1, 228-2 may also be collectively referred to as an anchor member coupling section.

Accordingly, the anchor coupling region of the first and second anchor members 104-1, 104-2 can be deformed by a user to insert the same between the opening 230 (See FIG. 2) and removably couple to an associated attachment member. In the context of the anchor coupling region of the first and second anchor members being a sleeve, this allows for a user to insert respective hook portions, e.g., the first and second hook portions 228-1, 228-2 of FIG. 2, into the sleeve for coupling purposes.

Note, in some examples the anchor members may be simply webbing provided by, for instance, PALS webbing. In such examples, the webbing provides at least one mounting slot (or sleeve) to couple to an associated attachment member, for example, at least one mounting slot configured to receive the first and second hook portions of an attachment member. Accordingly, attachment members as variously disclosed herein can couple directly to a strap anchor point, e.g., such as webbing without an intervening member, or indirectly by way of an intermediate anchor member such as a closed-loop shock cord.

FIG. 3 shows an example embodiment 300 of the strap system 100 of FIG. 1. As shown, the first strap segment 102-1 (See FIG. 1) may be removed/omitted depending on a desired configuration. As further shown, the second and third strap segments 102-2, 102-3 may be separable from each other and decoupled to provide two different straps, such as shown in FIG. 3.

Like numerals are intended to refer to like elements between figures. Accordingly, elements such as the first and second attachment members 310-1, 310-2 may be configured substantially the same as attachment member 110-N as discussed above, the description of which will not be repeated for brevity.

In this example, the second strap segment 302-2 can include a first end coupled to a first removable attachment member 330-1 and a second end coupled to a first anchor member 304-1 by way of a first attachment member 310-1 (which may also be referred to as a fixed attachment member herein). In addition, FIG. 3 illustrates that the third strap segment 102-3 can include a first end coupled to a second anchor member 304-2 by way of a second attachment member 310-2 (which may also be referred to as a fixed attachment member), and a second end coupled to a second removable attachment member 330-2. The first and second removable attachment members 330-1, 330-2 may also be referred to as temporary attachment members.

Continuing on, the first and second coupling members 306-1, 306-2 may removably couple to the first and second removable attachment members 330-1, 330-2, respectively. For example, the first and second coupling members 306-1, 306-2 can be implemented as side release buckles, and the first and second removable attachment members 330-1, 330-2 can be implemented to provide the mating buckle portion to allow for quick release coupling to respective ones of the first and second coupling members 306-1, 306-2.

FIG. 4 shows an example removable attachment member 330-N that maybe implemented as the removable attachment member 330-1 and/or 330-2 of FIG. 3. As shown, the removable attachment member 330-N defines a substantially C-shaped hook profile similar to the attachment member 110-N as shown and discussed above with regard to FIG. 2. However, the removable attachment member 330-N may comprises a material such as plastic (nylon, acetal) and is further configured to releasably couple to the first and second strap segments 302-2, 302-3 rather than be fixed to the same.

As shown, the removable attachment member 330-N extends along a longitudinal axis 450. Hook portions 222-1, 222-2 of the removable attachment member 330-N then extend substantially transverse relative to the longitudinal axis 450 and define an opening/mouth therebetween. Each of the hook portions 222-1, 222-2 can include first and second angled surfaces that extend at fifth and sixth angles (θ₅, θ₆), respectively, relative to the longitudinal axis 450. Preferably, the first and second angled surfaces extend substantially parallel with each other. The fifth and sixth angles (θ₅, θ₆) can measure, for example, between 45 and 315 degrees relative to the longitudinal axis 450. The removable attachment member 330-N may be configured to couple to, for example, PALS webbing, and/or other strap attachment points such as those the first and second attachment members 310-1, 310-2 can couple to.

Some aspects and features of a strap configured consistent with the present disclosure may be best understood by way of example. FIG. 5 shows a strap 502 with at least one end having an attachment member implemented as a closed-loop shock cord that is coupled to the frame of a motorcycle. A second end of the strap 502 (not shown) can include a similar configuration and couple on an opposite side of the frame of the motorcycle. Gear 560 may then be tensioned against the motorcycle by the strap 502 extending over the same and providing a compressive force, e.g., similar to a bungee cord strap. A second strap 580 consistent with the present disclosure may be optionally used to secure a second end of the gear 560 to the motorcycle. The second strap 580 can be configured to have associated attachment members, preferably implemented as C-shaped hook attachment members as disclosed herein, to couple together to provide a “floating” strap anchor point below the motorcycle frame, such as is more clearly shown in FIG. 10.

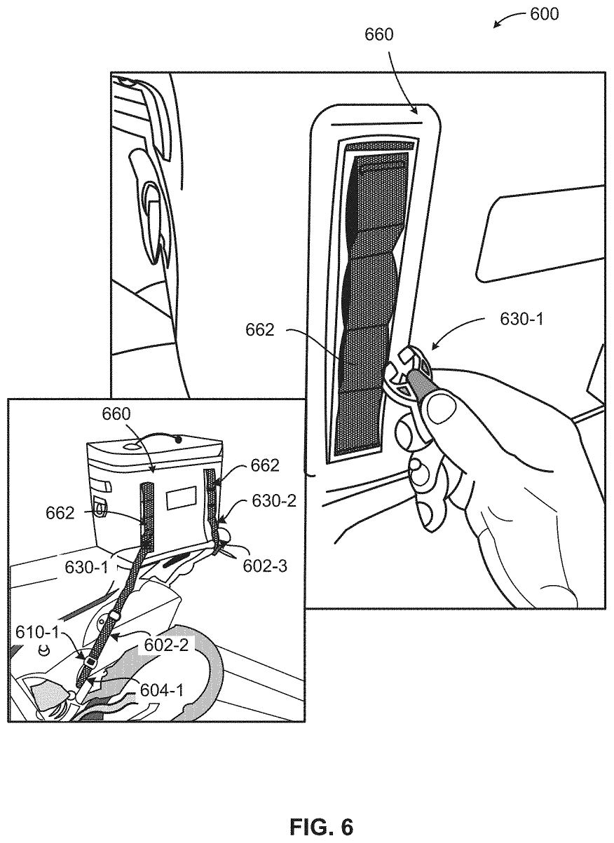

FIG. 6 shows a second strap segment 602-2 having a first end with a removable attachment member 630-1 that couples to a webbing 662, e.g., a PALS webbing, provided by gear 660. In this example, the gear 660 is a cooler that provides webbing 662 disposed a sidewall. The second strap segment 602-2 further includes an anchor member 604-1 at a second end that is implemented as a closed-loop shock cord, and couples to the same by way of attachment member 610-1. The anchor member 604-1 then couples to the strap anchor point, e.g., the frame of the motorcycle, by looping about the same. As further shown, the third strap segment 602-3 can also include one or more removable attachment members, e.g., removable attachment member 630-2, coupled to the webbing 662, and preferably, a removable attachment member coupled to each side of the gear 660 such that a portion of the third strap segment extends beneath the a portion of the motorcycle frame to tension and secure the gear 660 to the same.

FIG. 7 shows an example of how a strap 702, consistent with aspects of the present disclosure, includes attachment member 710-1 that can be used to couple gear 764 to the top of the gear 760 by way of webbing 762. The strap 702 can preferably include a second attachment member (not shown) for coupling to the webbing 762 of the gear 760 which is disposed on an opposite side of the gear 760 relative to the side providing webbing 762.

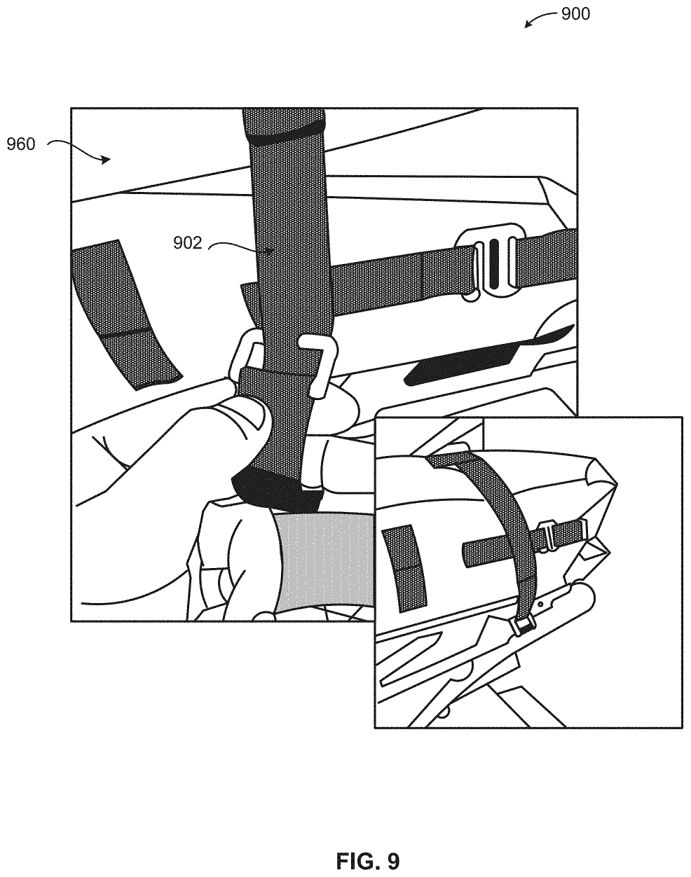

FIG. 8 shows an enlarged portion of the example shown in FIG. 5. FIG. 9 shows an example of a strap 902 consistent with the present disclosure being coupled to itself to tension and secure gear 960 to a motorcycle frame. FIG. 10 shows another example of a strap 580 consistent with the present disclosure that couples to itself via associated attach members to form a floating anchor connection point (also referred to herein as a floating strap anchor point) for tensioning gear against the motorcycle frame.

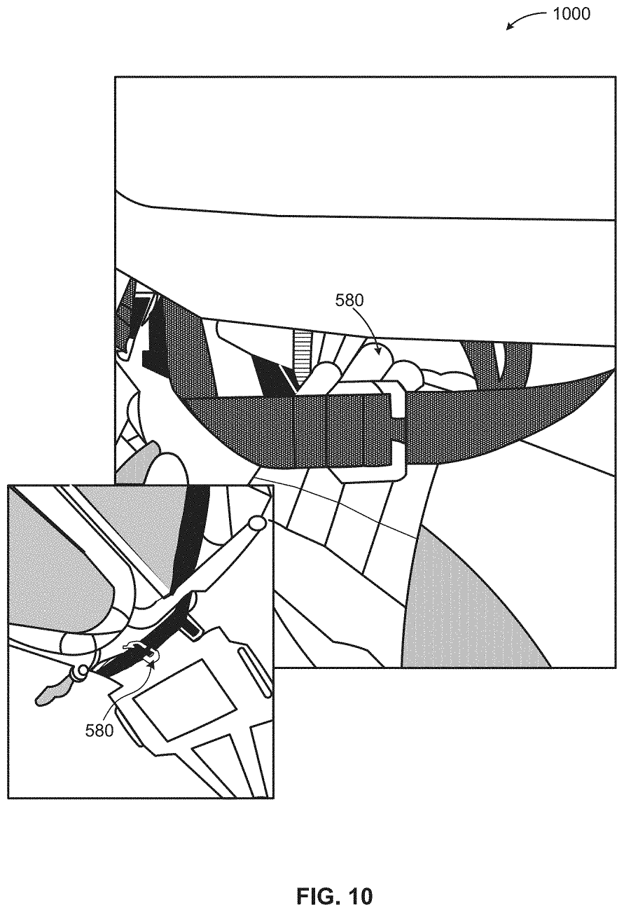

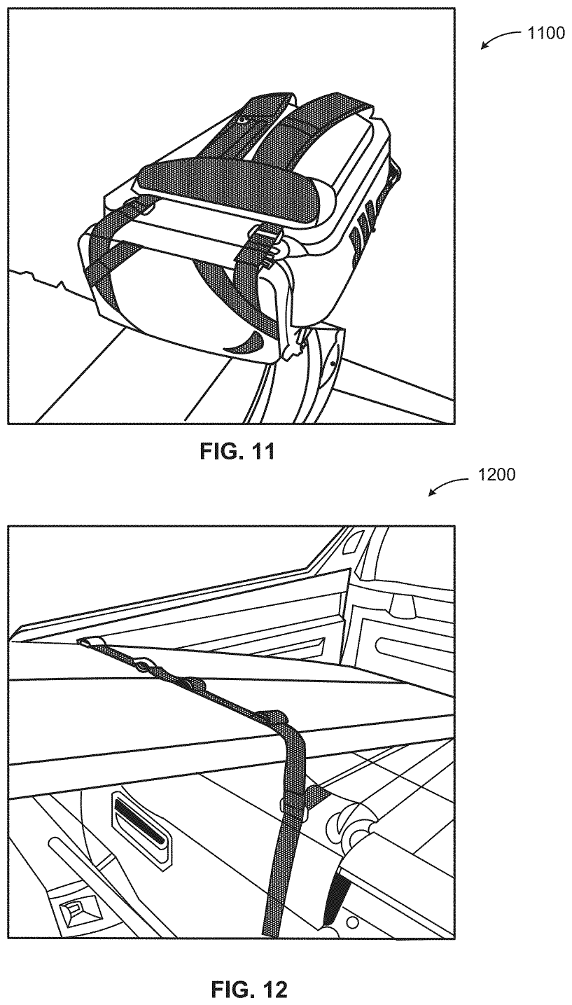

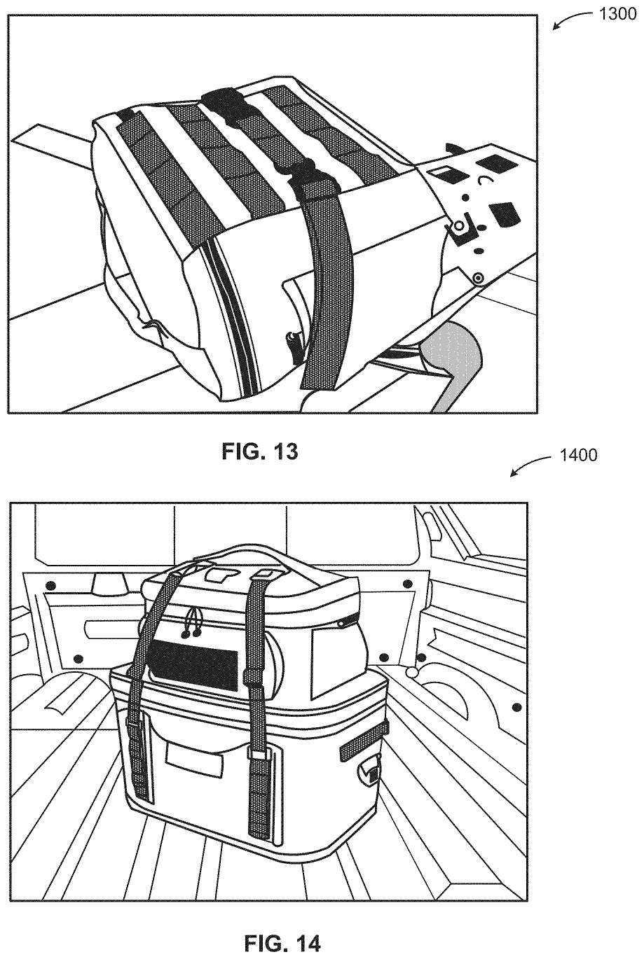

FIGS. 11-14 each show examples of one or more straps consistent with the present disclosure being utilized to securely couple gear to a desired location.

According to example 1, there is provided a strap. The strap may include: at least one strap segment; a first attachment member coupled adjacent a first end of the at least one strap segment, the first attachment member having a substantially C-shaped hook profile based on a stem and first and second arms that extend therefrom; and wherein the first attachment member is configured to removably couple to a first anchor member based on the first and second arms of the first attachment member defining first and second hook portions, respectively, the first and second hook portions configured to be received within a mounting slot of the first anchor member for coupling purposes.

Example 2 may include a second attachment member disposed adjacent a second end of the at least one strap segment, the second attachment member having a substantially C-shaped hook profile based on a stem and first and second arms that extend therefrom.

Example 3 may include any of the examples of 1 through 2, wherein the at least one strap segment may comprise a plurality of removably coupled strap segments, and wherein the plurality of removably coupled strap segments may include a first strap segment configured to removably couple to second and third strap segments, each of the second and third strap segments having a first end to couple to the first strap segment and a second end to couple to a respective one of the first and second attachment members.

Example 4 may include any of the examples of 1 through 3, wherein the first strap segment may have an overall length L1 that is less than an overall length L2 of the second and/or third strap segments.

Example 5 may include any of the examples of 1 through 4, wherein the second and/or third strap segments may include an associated strap adjuster to allow a user to select an overall length of the second and/or third strap segments for tensioning purposes.

Example 6 may include any of the examples of 1 through 5, wherein the first strap segment may be configured to removably couple to the second and third strap segments via first and second side release buckles, respectively.

Example 7 may include any of the examples of 1 through 6, wherein the first and second side release buckles may comprise at least one of polypropylene, nylon, and/or acetal.

Example 8 may include any of the examples of 1 through 7, wherein the at least one strap segment may comprise at least one of nylon webbing, polypropylene webbing, and/or rubber, synthetic rubber.

Example 9 may include any of the examples of 1 through 8, further comprising the first anchor member coupled to the at least one strap segment via the first attachment member, the first anchor member comprising a loop.

Example 10 may include any of the examples of 1 through 9, wherein the loop may be a closed loop of shock cord.

Example 11 may include any of the examples of 1 through 10, wherein the at least one strap segment may include a quick release buckle disposed at an end, and wherein the strap further may comprise a removable attachment member that includes a substantially C-shaped hook profile that couples to the at least one strap segment via the quick release buckle.

Example 12 may include any of the examples of 1 through 11, wherein the first attachment member may comprise a metal or metal alloy.

Example 13 may include any of the examples of 1 through 12, wherein the first attachment member may be configured to directly couple to a webbing.

Example 14 may a mounting system for securely mounting one or more items to a strap anchor point. The system may include: a strap, the strap comprising: at least one strap segment formed of a flexible material; a first attachment member disposed adjacent a first end of the at least one strap segment, the first attachment member formed of a rigid material and having a substantially C-shaped hook profile based on a stem and first and second hook arms that extend therefrom; a second attachment member disposed adjacent a second end of the at least one strap segment, the second attachment member formed of a rigid material and having a substantially C-shaped hook profile based on a stem and first and second hook arms that extend therefrom; and wherein the first attachment member and the second attachment member are configured to removably couple to first and second anchor members, respectively, based on the first and second attachment members being at least partially received within a mounting slot defined by respective ones of the first and second anchor members.

Example 15 may include any of the example 14, wherein the at least one strap segment may comprise a plurality of strap segments, and wherein the plurality of strap segments may include a first strap segment configured to removably couple to second and third strap segments, each of the second and third straps segments having a first end to couple to the first strap segment and a second end to couple to a respective one of the first and second attachment members.

Example 16 may include any of the examples of 14 through 15, wherein the first strap segment may have an overall length that is less than the overall length of the second and/or third strap segments.

Example 17 may include any of the examples of 14 through 16, wherein the second and third strap segments may each include a strap adjuster to allow a user-supplied force to select an overall length of the second and third strap segments for tensioning purposes.

Example 18 may include any of the examples of 14 through 17, wherein the first strap segment may be configured to removably couple to the second and third strap segments via first and second side release buckles, respectively.

Example 19 may include any of the examples of 14 through 18, wherein the first and second side release buckles may comprise at least one of polypropylene, nylon, and/or acetal.

Example 20 may include any of the examples of 14 through 19, wherein the at least one strap segment may comprise at least one of nylon webbing, polypropylene webbing, and/or rubber, synthetic rubber.

Example 21 may include any of the examples of 14 through 20, further comprising the first and second anchor members, each of the first and second anchor members may comprise a loop.

Example 22 may include any of the examples of 14 through 21, wherein the loop of the first and second anchor members may be implemented as a shock cord.

Example 23 may include any of the examples of 14 through 22, wherein the stem and first and second arms forming the first attachment member may be substantially co-planar.

Example 24 may include any of the examples of 14 through 23, wherein the first attachment member may comprise a metal or metal alloy.

Example 25 may include any of the examples of 14 through 24, wherein the first attachment member may be configured to directly couple to MOLLE and PALS webbing.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. It will be appreciated by a person skilled in the art that an apparatus may embody any one or more of the features contained herein and that the features may be used in any particular combination or sub-combination. Modifications and substitutions by one of ordinary skill in the art are considered to be within the scope of the present disclosure, which is not to be limited except by the claims.

What is claimed is:

1. A strap, the strap comprising:
at least one strap segment;
a first attachment member coupled adjacent a first end of the at least one strap segment, the first attachment member having a substantially C-shaped hook profile based on a stem and first and second arms that extend therefrom; and
wherein the first attachment member is configured to removably couple to a first anchor member based on the first and second arms of the first attachment member defining first and second hook portions, respectively, the first and second hook portions configured to be received within a mounting slot of the first anchor member for coupling purposes.

2. The strap of claim 1, further comprising a second attachment member disposed adjacent a second end of the at least one strap segment, the second attachment member having a substantially C-shaped hook profile based on a stem and first and second arms that extend therefrom.

3. The strap of claim 2, wherein the at least one strap segment comprises a plurality of removably coupled strap segments, and wherein the plurality of removably coupled strap segments include a first strap segment configured to removably couple to second and third strap segments, each of the second and third strap segments having a first end to couple to the first strap segment and a second end to couple to a respective one of the first and second attachment members.

4. The strap of claim 3, wherein the first strap segment has an overall length L1 that is less than an overall length L2 of the second and/or third strap segments.

5. The strap of claim 3, wherein the second and/or third strap segments include an associated strap adjuster to allow a user to select an overall length of the second and/or third strap segments for tensioning purposes.

6. The strap of claim 3, wherein the first strap segment is configured to removably couple to the second and third strap segments via first and second side release buckles, respectively.

7. The strap of claim 6, wherein the first and second side release buckles comprise at least one of polypropylene, nylon, and/or acetal.

8. The strap of claim 1, wherein the at least one strap segment comprises at least one of nylon webbing, polypropylene webbing, and/or rubber, synthetic rubber.

9. The strap of claim 1, further comprising the first anchor member coupled to the at least one strap segment via the first attachment member, the first anchor member comprising a loop.

10. The strap of claim 9, wherein the loop is a closed loop of shock cord.

11. The strap of claim 1, wherein the at least one strap segment includes a quick release buckle disposed at an end, and wherein the strap further comprises a removable attachment member that includes a substantially C-shaped hook profile that couples to the at least one strap segment via the quick release buckle.

12. The strap of claim 1, wherein the first attachment member comprises a metal or metal alloy.

13. The strap of claim 1, wherein the first attachment member is configured to directly couple to a webbing.

14. A mounting system for securely mounting one or more items to a strap anchor point, the system comprising:
a strap, the strap comprising:
at least one strap segment formed of a flexible material;
a first attachment member disposed adjacent a first end of the at least one strap segment, the first attachment member formed of a rigid material and having a substantially C-shaped hook profile based on a stem and first and second hook arms that extend therefrom;
a second attachment member disposed adjacent a second end of the at least one strap segment, the second attachment member formed of a rigid material and having a substantially C-shaped hook profile based on a stem and first and second hook arms that extend therefrom; and
wherein the first attachment member and the second attachment member are configured to removably couple to first and second anchor members, respectively, based on the first and second attachment members being at least partially received within a mounting slot defined by respective ones of the first and second anchor members.

15. The mounting system of claim 14, wherein the at least one strap segment comprises a plurality of strap segments, and wherein the plurality of strap segments include a first strap segment configured to removably couple to second and third strap segments, each of the second and third straps segments having a first end to couple to the first strap segment and a second end to couple to a respective one of the first and second attachment members.

16. The mounting system of claim 15, wherein the first strap segment has an overall length that is less than the overall length of the second and/or third strap segments.

17. The mounting system of claim 15, wherein the second and third strap segments each include a strap adjuster to allow a user-supplied force to select an overall length of the second and third strap segments for tensioning purposes.

18. The mounting system of claim 15, wherein the first strap segment is configured to removably couple to the second and third strap segments via first and second side release buckles, respectively.

19. The mounting system of claim 18, wherein the first and second side release buckles comprise at least one of polypropylene, nylon, and/or acetal.

20. The mounting system of claim 14, wherein the at least one strap segment comprises at least one of nylon webbing, polypropylene webbing, and/or rubber, synthetic rubber.

21. The mounting system of claim 14, further comprising the first and second anchor members, each of the first and second anchor members comprising a loop.

22. The mounting system of claim 21, wherein the loop of the first and second anchor members is implemented as a shock cord.

23. The mounting system of claim 14, wherein the stem and first and second arms forming the first attachment member are substantially co-planar.

24. The mounting system of claim 14, wherein the first attachment member comprises a metal or metal alloy.

25. The mounting system of claim 14, wherein the first attachment member is configured to directly couple to MOLLE and PALS webbing.
